(19) United States
(12) Patent Application Publication
(10) Pub. No.: US 2012/0072206 A1
(43) Pub. Date: Mar. 22, 2012

(54) TERMINAL APPARATUS AND SPEECH PROCESSING PROGRAM

(75) Inventors: Yoshiteru Tsuchinaga, Fukuoka (JP); Kaori Endo, Kawasaki (JP)

(73) Assignee: FUJITSU LIMITED, Kawasaki-shi (JP)

(21) Appl. No.: 13/192,092

(22) Filed: Jul. 27, 2011

(30) Foreign Application Priority Data
Sep. 17, 2010 (JP) 2010-209936

(51) Int. Cl. G10L 19/00

(52) U.S. Cl. 704/201; 704/E11.001

(57) ABSTRACT

A terminal apparatus configured to obtain positional information indicating a position of another apparatus; to obtain positional information indicating a position of the terminal apparatus; to obtain a first direction, which is a direction to the obtained position of the another apparatus and calculated using the obtained position of the terminal apparatus; to obtain a second direction, which is a direction in which the terminal apparatus is oriented; to obtain inclination information indicating whether the terminal apparatus is inclined to the right or to the left; to switch an amount of correction for a relative angle between the first direction and the second direction in accordance with whether the obtained inclination information indicates an inclination to the right or an inclination to the left; and to determine an attribute of speech output from a speech output unit in accordance with the relative angle corrected by the amount of correction.

### CROSS-REFERENCE TO RELATED APPLICATIONS

This application is related to and claims priority to Japanese Patent Application No. 2010-209936 filed on Sep. 17, 2010, the entire contents of which are herein incorporated by reference.

### BACKGROUND

1. Field

The present invention relates to a terminal apparatus and a speech processing program.

2. Description of the Related Art

Currently, there is an example of the related art in which, when a telephone call is conducted using a terminal apparatus such as a mobile phone or a smartphone, a user is informed of the direction of a person with whom he/she is conducting the telephone call by calculating the direction of the person with whom the user is conducting the telephone call and processing speech during the telephone call in accordance with the direction. The related art will be described hereinafter with reference to FIGS. 16 and 17. FIGS. 16 and 17 are used to describe the related art. For example, “U1” and “U2” illustrated in FIG. 16 indicate persons who are conducting a telephone call with each other.

In the related art, first, the positional information of a terminal apparatus used by “U2” is obtained, and then the positional relationship between a terminal apparatus used by “U1” and the terminal apparatus used by “U2” is obtained. It is to be noted that the positional information is obtained by, for example, using a Global Positioning System (GPS) or the like.

Next, in the related art, as illustrated in FIG. 16, an angle θ1 between a direction from the position of the terminal apparatus used by “U1” to the position of the terminal apparatus used by “U2” and the north direction is obtained. Next, in the related art, as illustrated in FIG. 16, an angle θ2 between the terminal direction of the terminal apparatus used by “U1” and the north direction is obtained on the assumption that a front direction F_{D} of “U1” and the terminal direction of the terminal apparatus used by “U1” are the same. The terminal direction corresponds to, for example, the longitudinal direction of the terminal apparatus. The angle θ2 can be obtained by using an electronic compass incorporated into the terminal apparatus or the like.

Next, in the related art, as illustrated in FIG. 16, a relative angle θ of the direction from the position of the terminal apparatus used by “U1” to the position of the terminal apparatus used by “U2” in relation to the terminal direction of the terminal apparatus used by “U1” is obtained on the basis of the angle θ1 and the angle θ2. Next, in the related art, output speech is generated in accordance with the relative angle θ. For example, in the related art, as illustrated in FIG. 17, speech for the left ear and speech for the right ear are separately generated in accordance with the relative angle θ and output with systems that are different between the left and the right. For example, the speech for the left ear and the speech for the right ear are output with the different systems for the left and the right through speakers incorporated into the terminal apparatus, headphones or earphones connected to the terminal apparatus, or the like. Thus, in the related art, the direction of a person with whom a user is conducting a telephone call is expressed by the difference between speech for the left ear and speech for the left ear to be output, thereby allowing the user to perceive the speech of the person in such a way that the speech is heard from the direction of the terminal apparatus used by the person with whom the user is conducting the telephone call.

Japanese Unexamined Patent Application Publication No. 2008-184621 and Japanese Unexamined Patent Application Publication No. 2005-341092 are documents relating to the above description.

### SUMMARY

It is an aspect of the embodiments discussed herein to provide a terminal apparatus which obtains positional information indicating a position of another apparatus, and which obtains positional information indicating a position of the terminal apparatus.

The terminal apparatus is operable to obtain a first direction, which is a direction to the obtained position of the another apparatus and calculated using the obtained position of the terminal apparatus as a reference point.

The terminal apparatus is operable to obtain a second direction, which is a direction in which the terminal apparatus is oriented.

The terminal apparatus is operable to obtain, using a sensor that detects a direction in which the terminal apparatus is inclined, inclination information indicating whether the terminal apparatus is inclined to the right or to the left.

The terminal apparatus is operable to switch an amount of correction for a relative angle between the first direction and the second direction in accordance with whether the obtained inclination information indicates an inclination to the right or an inclination to the left.

The terminal apparatus is operable to determine an attribute of speech output from a speech output unit in accordance with the relative angle corrected by the amount of correction.

The object and advantages of the invention will be realized and attained by AT LEAST the elements, FEATURES, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates a functional block diagram of a terminal apparatus according to a first embodiment.

FIG. 2 illustrates function of a direction obtaining unit according to the first embodiment.

FIG. 3 illustrates function of a calculation unit according to the first embodiment.

FIG. 4A illustrates function of a judgment unit according to the first embodiment.

FIG. 4B illustrates function of the judgment unit according to the first embodiment.

FIG. 5A illustrates function of a correction unit according to the first embodiment.

FIG. 5B illustrates function of the correction unit according to the first embodiment.

FIG. 6 illustrates function of the correction unit according to the first embodiment.

FIG. 7 illustrates function of a generation unit according to the first embodiment.

FIG. 8 illustrates function of the generation unit according to the first embodiment.

FIG. 9 illustrates function of a mixing unit according to the first embodiment.

FIG. 10 illustrates function of the generation unit according to the first embodiment.

FIG. 11 illustrates the general processing flow of the terminal apparatus according to the first embodiment.

FIG. 12 illustrates the flow of a telephone call state detection process according to the first embodiment.

FIG. 13 illustrates the flow of a hold type judgment process according to the first embodiment.

FIG. 14 illustrates the flow of a direction correction process according to the first embodiment.

FIG. 15 illustrates an example of the hardware configuration of a terminal apparatus according a second embodiment.

FIG. 16 illustrates function of a terminal apparatus according to the related art.

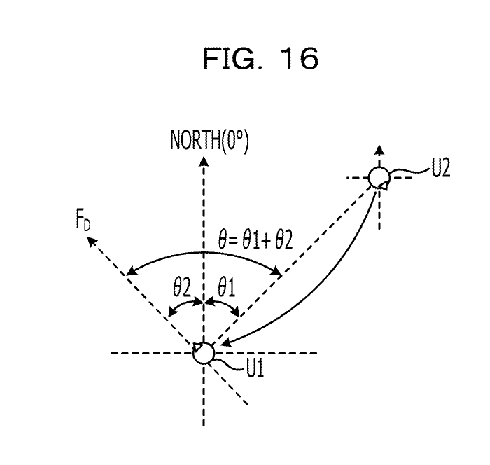

FIG. 17 illustrates function of a terminal apparatus according to the related art.

### DETAILED DESCRIPTION OF THE EMBODIMENTS

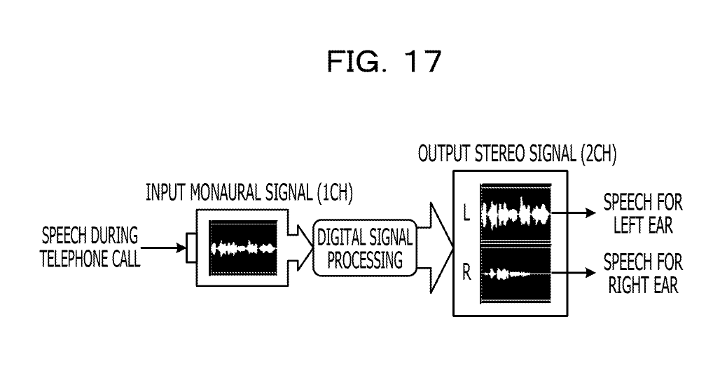

In the above-described related art, as illustrated in FIG. 17, the direction of a person with whom a user is conducting a telephone call is expressed by the difference between speech for the left ear and speech for the right ear in order to allow the user to perceive the direction of the person with whom he/she is conducting the telephone call. Therefore, in a case where a user conducts a telephone call while using either of his/her ears, the method cannot be used in which the direction of a person with whom the user is conducting a telephone call is expressed by the difference between speech for the left ear and speech for the right ear, which poses a problem in that it is impossible for the user to perceive the direction of the person with whom he/she is conducting the telephone call.

In addition, in the above-described related art, the relative angle θ is obtained on the assumption that the front direction of a user and the terminal direction are the same, and then output speech is generated in accordance with the relative angle θ. Therefore, in a situation in which the front direction of a user and the terminal direction are not the same, it is impossible for the user to exactly perceive the direction of a person with whom he/she is conducting a telephone call. It is to be noted that the front direction of a user and the terminal direction are not the same in most cases when the user conducts a telephone call while using either of his/her ears. Therefore, unless the above-mentioned relative angle θ is accurately calculated even in a situation in which the front direction of a user and the terminal direction are not the same, it is impossible for the user who is conducting a telephone call while using either of his/her ears to exactly perceive the direction of a person with whom he/she is conducting the telephone call.

In an embodiment of the technology that will be described hereinafter, therefore, a terminal apparatus and a speech processing program are provided that are capable of allowing a user who is conducting a telephone call with a person while using either of his/her ears to accurately perceive the direction of the person with whom he/she is conducting the telephone call.

An embodiment of a terminal apparatus that will be disclosed hereinafter includes an another-terminal position obtaining unit, an own-terminal position obtaining unit, a first direction obtaining unit, a second direction obtaining unit, an inclination direction obtaining unit, a correction unit, and a determination unit. The another-terminal position obtaining unit obtains positional information indicating a position of another apparatus. The own-terminal position obtaining unit obtains positional information indicating a position of the terminal apparatus. The first direction obtaining unit obtains a first direction, which is a direction to the obtained position of the another-terminal apparatus and calculated using the obtained position of the own-terminal apparatus as a reference point. The second direction obtaining unit obtains a second direction, which is a direction in which the own-terminal apparatus is oriented. The inclination direction obtaining unit obtains, using a sensor that detects a direction in which the own-terminal apparatus is inclined, inclination information indicating whether the own-terminal apparatus is inclined to the right or to the left. The correction unit switches an amount of correction for a relative angle between the first direction and the second direction in accordance with whether the obtained inclination information indicates an inclination to the right or an inclination to the left. The determination unit determines an attribute of speech output from a speech output unit in accordance with the relative angle corrected by the amount of correction.

According to an embodiment that will be described hereinafter, it is possible to allow a user who is conducting a telephone call with a person while using either of his/her ears to exactly perceive the direction of the person with whom he/she is conducting the telephone call.

An embodiment of the terminal apparatus and the speech processing program that are disclosed herein will be described hereinafter in detail with reference to the drawings. It is to be understood that the technology disclosed herein is not limited by the embodiment that will be described as an embodiment of the terminal apparatus and the speech processing program that are disclosed herein.

### First Embodiment

### Configuration of Terminal Apparatus (First Embodiment)

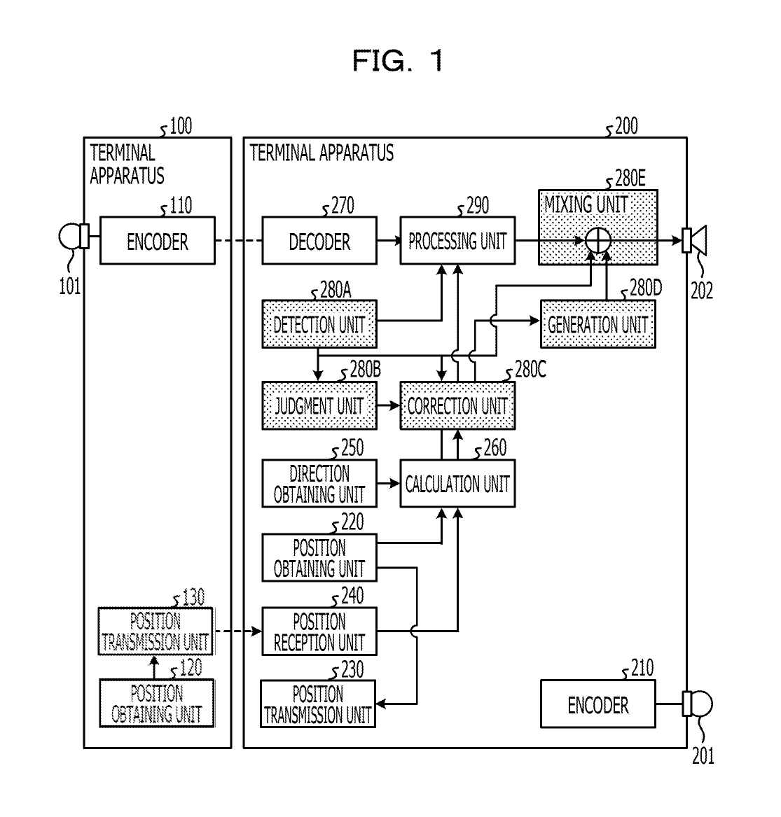

FIG. 1 is a functional block diagram illustrating the configuration of a terminal apparatus according to a first embodiment. In FIG. 1, an example is illustrated in which a terminal apparatus 100 is an apparatus used by a person with whom a user conducts a telephone call and a terminal apparatus 200 is an apparatus used by the user. The terminal apparatus 100 and the terminal apparatus 200 are, for example, mobile terminals that allow users to conduct a telephone call with other people and that are capable of obtaining positional information, such as mobile phones, smartphones, or Personal Handy-phone Systems (PHSs). It is to be noted that although the terminal apparatus 100 and the terminal apparatus 200 illustrated in FIG. 1 are apparatuses having the same configuration, only processing function units that are necessary to describe an embodiment in which speech transmitted from the terminal apparatus 100 is received by the terminal apparatus 200 will be described in the first embodiment below.

As described in FIG. 1, the terminal apparatus 100 has a microphone 101, an encoder 110, a position obtaining unit 120, and a position transmission unit 130. The microphone 101 receives speech uttered by a user of the terminal apparatus 100. The encoder 110 encodes the speech uttered by the user, which has been received by the microphone 101. The speech encoded by the encoder 110 is transmitted to the terminal apparatus 200.

The position obtaining unit 120 obtains the positional information of the terminal apparatus 100. The position obtaining unit 120 obtains the position of the terminal apparatus 100 on a plane rectangular coordinate system on the basis of, for example, the latitude and the longitude obtained by using a GPS or the like. The position of the terminal apparatus 100 will be represented as, for example, “sender_pos (x_sender, y_sender)” hereinafter. It is to be noted that the position of the terminal apparatus 100 on a plane rectangular coordinate system can be obtained by using existing technologies on the basis of the latitude and the longitude. An example of the existing technologies is disclosed in, for example, B. R. Bowring “TOTAL INVERSE SOLUTIONS FOR THE GEODESIC AND GREAT ELLIPTIC” (Survey Review 33, 261 (July, 1996) 461-476, URL “http://vldb.gsi.go.jp/sokuchi/surveycalc/algorithm/” (searched on Sep. 1, 2010)). In addition, another example of the existing technologies is disclosed in a URL “http://vldb.gsi.go.jp/sokuchi/surveycalc/algorithm/bl2xy/bl2xy.htm” (searched on Sep. 1, 2010). The position transmission unit 130 transmits, to the terminal apparatus 200, the positional information of the terminal apparatus 100 obtained by the position obtaining unit 120.

As illustrated in FIG. 1, the terminal apparatus 200 has a microphone 201, a speaker 202, an encoder 210, a position obtaining unit 220, a position transmission unit 230, a position reception unit 240, a direction obtaining unit 250, a calculation unit 260, and a decoder 270. Furthermore, the terminal apparatus 200 has a detection unit 280A, a judgment unit 280B, a correction unit 280C, a generation unit 280D, a mixing unit 280E, and a processing unit 290.

The microphone 201, the encoder 210, the position obtaining unit 220, and the position transmission unit 230 illustrated in FIG. 1 perform the same processes as the microphone 101, the encoder 110, the position obtaining unit 120, and the position transmission unit 130, respectively, of the terminal apparatus 100 described above. For example, the position obtaining unit 220 obtains the position of the terminal apparatus 200 on a plane rectangular coordinate system on the basis of the latitude and the longitude obtained by using the GPS or the like. The position obtaining unit 220 is an example of an own-terminal position obtaining unit. The position of the terminal apparatus 200 will be represented as, for example, “receiver_pos (x_receiver, y_receiver)” hereinafter. The position transmission unit 230 transmits, to the terminal apparatus 100, the positional information of the terminal apparatus 200 obtained by the position obtaining unit 220. Description of the microphone 201 and the encoder 210 is omitted.

The position reception unit 240 illustrated in FIG. 1 receives the positional information transmitted from the terminal apparatus 100. The position reception unit 240 is an example of an another-terminal position obtaining unit.

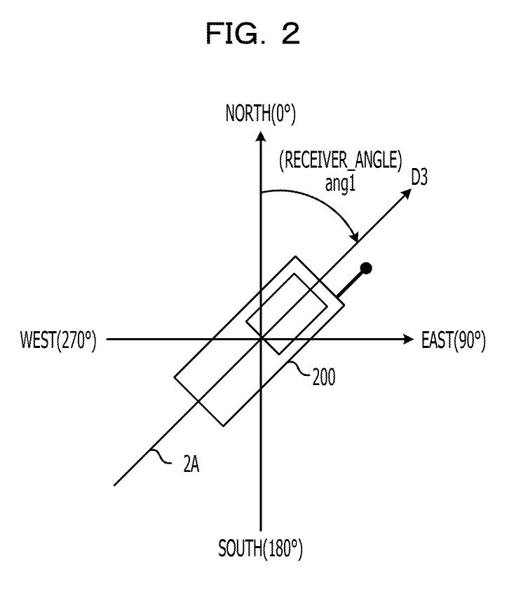

The direction obtaining unit 250 illustrated in FIG. 1 uses an electronic compass to obtain information regarding the terminal direction of the terminal apparatus 200. The direction obtaining unit 250 will be described with reference to FIG. 2. FIG. 2 is used to describe a direction obtaining unit according to the first embodiment.

As illustrated in FIG. 2, the direction obtaining unit 250 uses the electronic compass to obtain an angle “ang1 (receiver_angle)” between a terminal direction D3, which corresponds to the direction of a central longitudinal axis 2A of the terminal apparatus 200, and the north direction (0°).

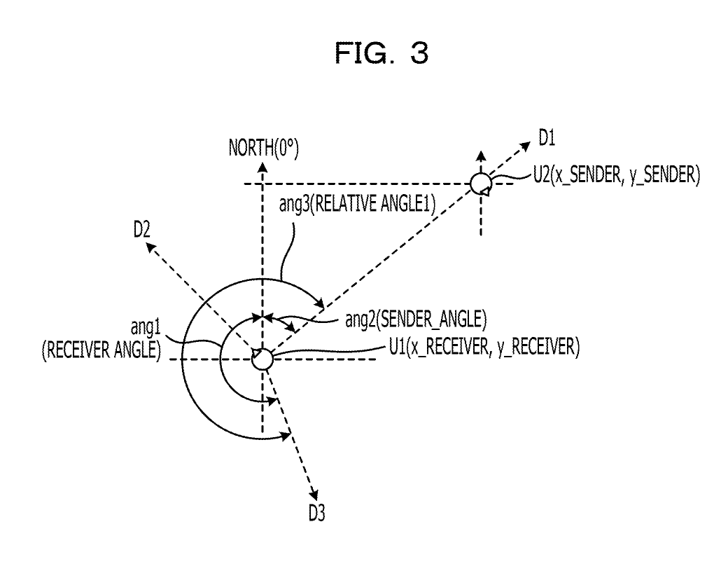

The calculation unit 260 illustrated in FIG. 1 obtains a relative angle of a direction from the position of the terminal apparatus 200 to the position of the terminal apparatus 100 in relation to the terminal direction of the terminal apparatus 200. The relative angle calculated by the calculation unit 260 will be represented as, for example, “ang3 (relative_angle1)” hereinafter. The calculation unit 260 will be described with reference to FIG. 3. FIG. 3 is used to describe a calculation unit according to the first embodiment. “U1” illustrated in FIG. 3 indicates a user who is using the terminal apparatus 200, and “U2” illustrated in FIG. 3 indicates a user who is using the terminal apparatus 100. In addition, “D1” illustrated in FIG. 3 indicates a direction from the terminal apparatus 200 to the terminal apparatus 100. In addition, “D2” illustrated in FIG. 3 indicates the direction of the user who is using the terminal apparatus 200, that is, the direction of the front of the user. In addition, “D3” illustrated in FIG. 3 indicates the terminal direction of the terminal apparatus 200. It is to be noted that “D3” illustrated in FIG. 3 corresponds to “D3” illustrated in FIG. 2.

First, the calculation unit 260 obtains the positional information (x_receiver, y_receiver) of the terminal apparatus 200 from the position obtaining unit 220 and the positional information (x_sender, y_sender) of the terminal apparatus 100 from the position reception unit 240. As illustrated in FIG. 3, the calculation unit 260 then obtains the direction D1 from the terminal apparatus 200 to the terminal apparatus 100 on the basis of the positional information of the terminal apparatus 200 and the terminal apparatus 100. As illustrated in FIG. 3, the calculation unit 260 then obtains an angle “ang2 (sender_angle)” between the direction D1 and the north direction (0°). For example, the calculation unit 260 can obtain the angle “ang2 (sender_angle)” using the following expression (1):

$$sender\_angle = {tan}^{- 1} ( \frac{x\_sender - x\_receiver}{y\_sender - y\_receiver} ) \frac{π}{180} \qquad ( 1 )$$

The calculation unit 260 then obtains the angle “ang1 (receiver_angle)” between the terminal direction D3 and the north direction from the direction obtaining unit 250. As illustrated in FIG. 3, the calculation unit 260 then obtains the above-described relative angle “ang3 (relative_angle1)” on the basis of the angle “ang1 (receiver_angle)” and the angle “ang2 (sender_angle)”. For example, the calculation unit 260 can obtain the relative angle “ang3 (relative_angle1)” using the following expression (2). It is to be noted that the calculation unit 260 is an example of a first direction obtaining unit and a second direction obtaining unit.

relative_angle1=receiver_angle+sender_angle (2)

The decoder 270 illustrated in FIG. 1 receives encoded speech from the terminal apparatus 100 and decodes the received speech.

The detection unit 280A illustrated in FIG. 1 detects the telephone call state of the user. For example, the detection unit 280A monitors the number of channels of a speech output path, that is, the number of output signals of speech. If the number of channels is 1, the detection unit 280A judges that the user is in a telephone call state in which he/she is using either of his/her ears. When the detection unit 280A has judged that the user is in a telephone call state in which he/she is using either of his/her ears, the detection unit 280A then sets, for a certain flag, a certain value (receiver_flag=1) indicating that the user is in a telephone call state in which he/she is using either of his/her ears.

In addition, if the number of channels is 2, the detection unit 280A judges that the user is in a telephone call state other than a telephone call state in which he/she is using either of his/her ears, that is, a telephone call state in which, for example, he/she is using headphones, earphones, or the like. When the detection unit 280A has judged that, for example, the user is in a telephone call state in which he/she is using headphones, earphones, or the like, the detection unit 280A then sets, for a certain flag, a certain value (receiver_flag=2) indicating that the user is in a telephone call state in which he/she is using headphones, earphones, or the like. It is to be noted that the detection unit 280A is an example of a telephone call state judgment unit.

It is to be noted that the detection unit 280A may be configured to judge whether or not a user who is beginning to conduct a telephone call is in a telephone call state in which he/she is using either of his/her ears by referring to, for example, a register in which information regarding the number of output signals of speech or the output state of speech such as monaural, stereo, or the like is stored.

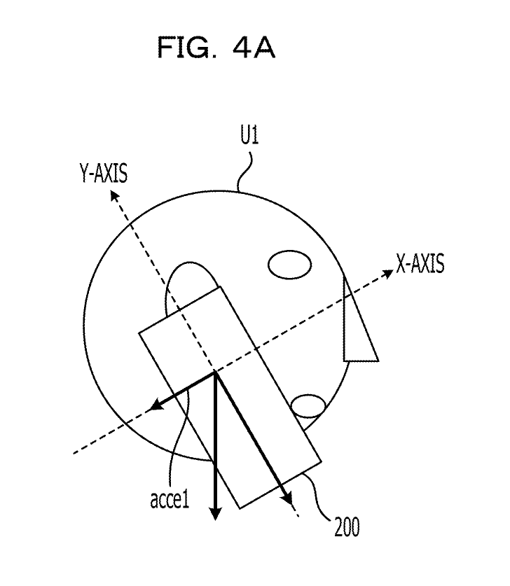

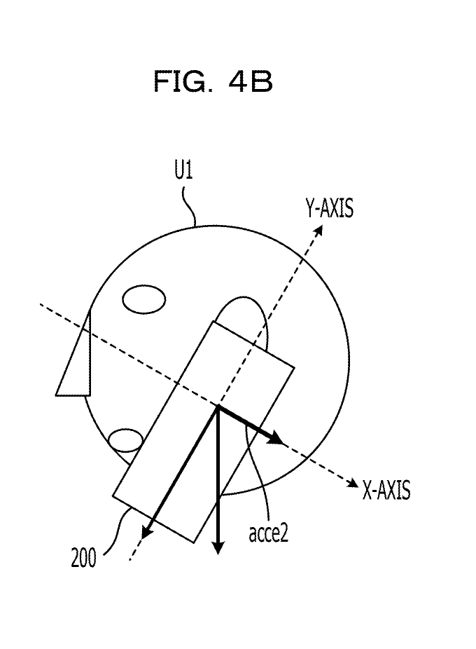

The judgment unit 280B illustrated in FIG. 1 judges, when the telephone call state of the user is one in which he/she is using either of his/her ears, whether the user is conducting the telephone call while using his/her right or left ear. The judgment unit 280B will be described with reference to FIGS. 4A and 4B. FIGS. 4A and 4B are used to describe a judgment unit according to the first embodiment. “U1” illustrated in FIGS. 4A and 4B indicates the user of the terminal apparatus 200 and corresponds to “U1” illustrated in FIG. 3. “acce1” illustrated in FIG. 4A indicates the negative acceleration along the x-axis of the terminal apparatus 200. “acce2” illustrated in FIG. 4B indicates the positive acceleration along the x-axis of the terminal apparatus 200.

For example, the judgment unit 280B obtains the value of a flag set by the detection unit 280A and judges whether or not the obtained value of a flag is a value (receiver_flag=1) indicating that the user is in a telephone call state in which he/she is using either of his/her ears. If it has been judged that the user is in a telephone call state in which he/she is using either of his/her ears, the judgment unit 280B obtains the acceleration of the terminal apparatus 200 from an acceleration sensor.

The judgment unit 280B then judges whether the user is conducting a telephone call while using his/her right or left ear on the basis of the obtained acceleration. For example, as illustrated in FIG. 4A, if the acceleration acce1 along the x-axis obtained from the acceleration sensor has a negative value, the judgment unit 280B judges that the user is conducting the telephone call while using his/her right ear. When the judgment unit 280B has judged that the user is conducting the telephone call while using his/her right ear, the judgment unit 280B then sets, for a certain flag, a certain value (hold_flag=0) indicating that the user is conducting a telephone call while using his/her right ear.

On the other hand, as illustrated in FIG. 4B, if the acceleration acce2 along the x-axis obtained from the acceleration sensor has a positive value, the judgment unit 280B judges that the user is conducting the telephone call while using his/her left ear. When the judgment unit 280B has judged that the user is conducting the telephone call while using his/her left ear, the judgment unit 280B then sets, for a certain flag, a certain value (hold_flag=1) indicating that the user is conducting a telephone call while using his/her left ear. The judgment unit 280B is an example of an inclination direction obtaining unit.

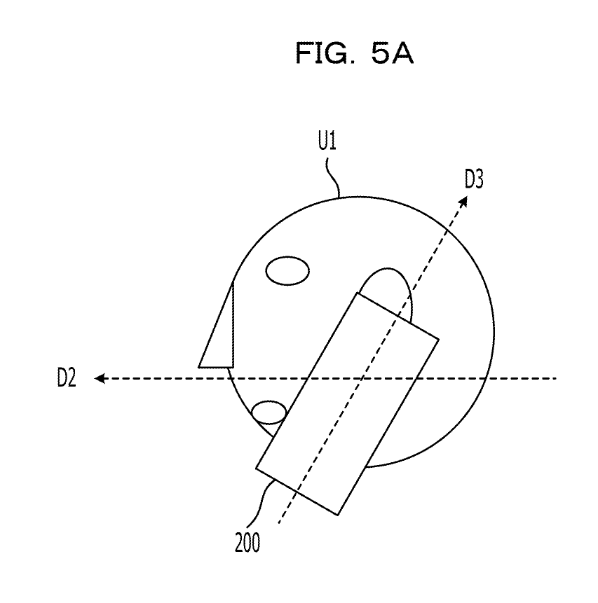

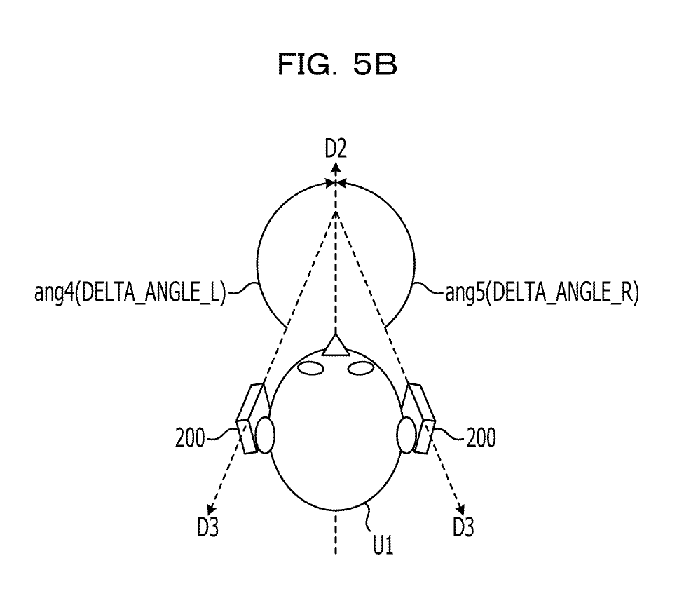

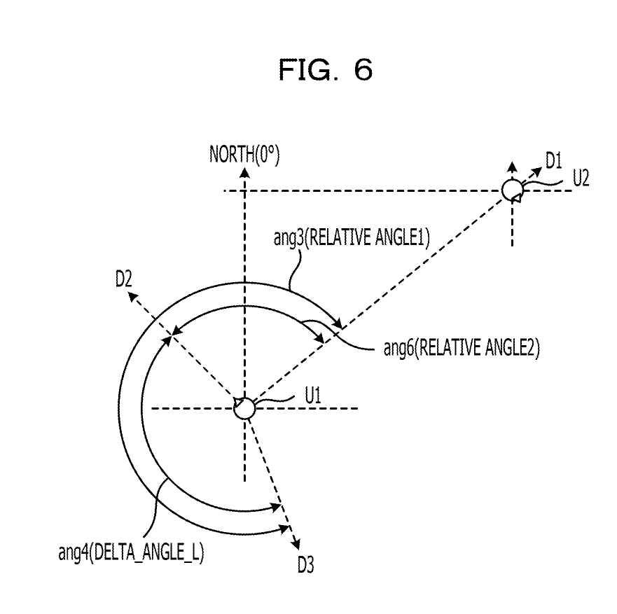

The correction unit 280C illustrated in FIG. 1 uses correction values predetermined for a telephone call in which the right ear is used and a telephone call in which the left ear is used in order to obtain a corrected relative angle, which is an angle obtained by correcting the relative angle “ang3 (relative_angle1)” calculated by the calculation unit 260. The corrected relative angle, which has been corrected by the correction unit 280C, will be represented as “ang6 (relative_angle2)” hereinafter. The correction unit 280C will be described with reference to FIGS. 5A, 5B, and 6.

FIGS. 5A, 5B, and 6 are used to describe a correction unit according to the first embodiment. FIG. 5A illustrates a situation in which a user who is conducting a telephone call using the terminal apparatus 200 is viewed from the left side. In addition, FIG. 5B illustrates a situation in which a user who is conducting a telephone call using the terminal apparatus 200 is viewed from above. In addition, “D2” illustrated in FIGS. 5A and 5B indicates the user direction and corresponds to “D2” illustrated in FIG. 3. In addition, “D3” illustrated in FIGS. 5A and 5B indicates the terminal direction of the terminal apparatus 200 and corresponds to “D3” illustrated in FIGS. 2 and 3.

For example, the correction unit 280C obtains the value of a flag set by the detection unit 280A and judges whether or not the obtained value of a flag is a value (receiver_flag=1) indicating that the user is in a telephone call state in which he/she is using either of his/her ears.

If it has been judged that the user is in a telephone call state in which he/she is using either of his/her ears, the correction unit 280C obtains the value of a flag set by the judgment unit 280B and judges whether the obtained value of a flag is a value indicating a telephone call in which the user's left ear is used or a value indicating a telephone call in which the user's right ear is used. If it has been judged that the obtained value of a flag is a value (hold_flag=1) indicating a telephone call in which the user's left ear is used, the correction unit 280C obtains a correction value “ang4 (delta_angle_L)” for a telephone call the left ear is used as illustrated in FIG. 5B. The correction unit 280C then obtains the relative angle “ang3 (relative_angle1)” calculated by the calculation unit 260. The correction unit 280C then, as illustrated in FIG. 6, uses the correction value “ang4 (delta_angle_L)” to correct the relative angle “ang3 (relative_angle1)”, thereby obtaining the corrected relative angle “ang6 (relative_angle2)”. The correction unit 280C thus obtains the corrected relative angle for a telephone call in which the left ear is used.

In the case of a telephone call in which the right ear is used, too, the corrected relative angle can be obtained in the same manner. For example, if the value of a flag set by the judgment unit 280B is a value (hold_flag=0) indicating a telephone call in which the user's right ear is used, the correction unit 280C obtains a correction value “ang5 (delta_angle_R)” for a telephone call in which the right ear is used as illustrated in FIG. 5B. The correction unit 280C then obtains the relative angle “ang3 (relative_angle1)” calculated by the calculation unit 260. The correction unit 280C then uses the correction value “ang5 (delta_angle_R)” to correct the relative angle “ang3 (relative_angle1)”, thereby obtaining the corrected relative angle “ang6 (relative_angle2)”. The correction unit 280C is an example of a correction unit.

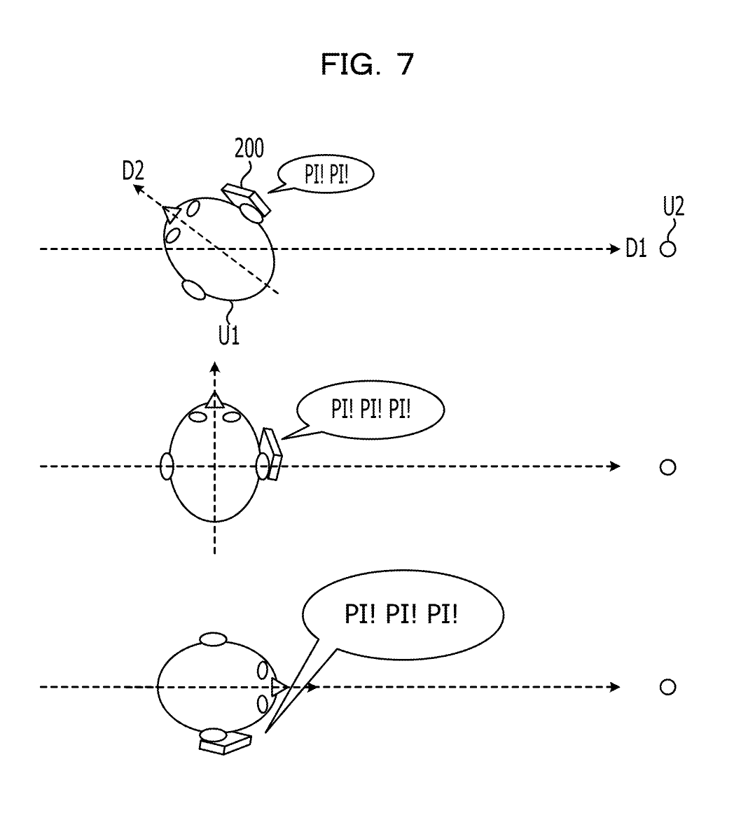

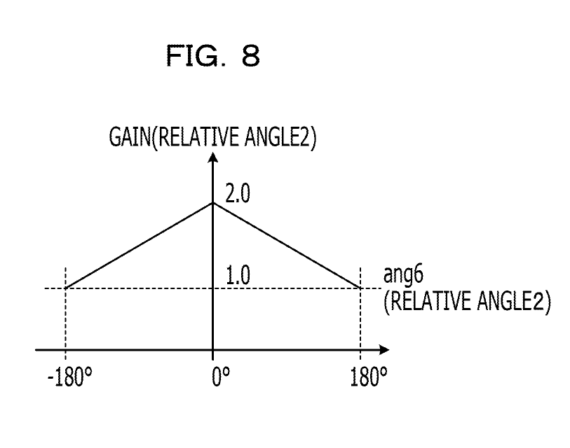

The generation unit 280D illustrated in FIG. 1 generates a characteristic sound to be mixed with speech received from the terminal apparatus 100 in accordance with the corrected relative angle obtained from the correction unit 280C. The generation unit 280D will be described with reference to FIGS. 7 and 8. FIGS. 7 and 8 are used to describe a generation unit according to the first embodiment. “D2” illustrated in FIG. 7 indicates the user direction and corresponds to “D2” illustrated in FIGS. 3, 5A, and 5B. In addition, “D1” illustrated in FIG. 7 indicates the direction of the terminal apparatus 100 and corresponds to “D1” illustrated in FIGS. 3 and 6. FIG. 8 indicates gain to be used when a characteristic sound is generated.

As illustrated in FIG. 7, the generation unit 280D generates a characteristic sound in accordance with the corrected relative angle obtained from the correction unit 280C in such a way that the volume of the characteristic sound becomes larger when the user direction D2 becomes closer to the direction D1 from the terminal apparatus 200 to the terminal apparatus 100. For example, the generation unit 280D generates a characteristic sound on the basis of the following expression (3):

artSig(n)=gain(relative_angle2)×pattern_sig: n=0, . . . , N−1 (3)

pattern_sig(n)(n=0, . . . , N−1): Pattern sound

gain(relative_angle2): Gain for adjusting volume

artSig(n): Characteristic sound

N: Frame length for speech processing

For example, as illustrated in FIG. 8, when the corrected relative angle “ang6 (relative_angle2)” is 180° or −180°, a minimum value “1” is set for the gain to be used by the generation unit 280D to generate a characteristic sound, in order for the volume of the characteristic sound to be adjusted to be the smallest. In addition, as illustrated in FIG. 8, when the corrected relative angle “ang6 (relative_angle2)” is 0°, a maximum value “2” is set, in order for the volume of the characteristic sound to be adjusted to be largest. In addition, as illustrated in FIG. 8, the gain for the generation unit 280D is set in such a way that the volume of the characteristic sound is adjusted to be larger as the corrected relative angle “ang6 (relative_angle2)” becomes closer to 0°. That is, the generation unit 280D uses the gain illustrated in FIG. 8 to generate a characteristic sound whose volume becomes larger as the user of the terminal apparatus 200 comes closer and closer to facing in the direction of the terminal apparatus 100.

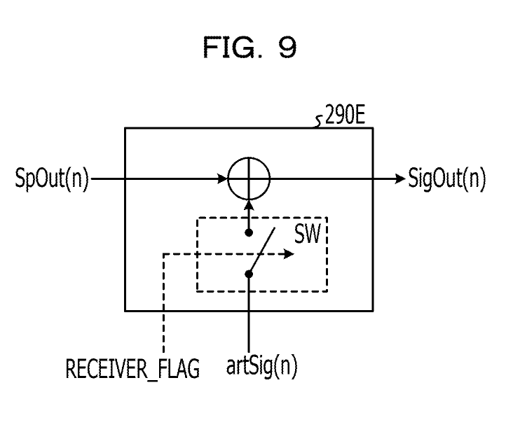

When the user is in a telephone call state in which he/she is using either of his/her ears, the mixing unit 280E mixes a characteristic sound generated by the generation unit 280D with speech input from the processing unit 290, which will be described later. The mixing unit 280E will be described with reference to FIG. 9. FIG. 9 is used to describe a mixing unit according to the first embodiment. “SpOut(n)” illustrated in FIG. 9 indicates speech input from the processing unit 290, and “SigOut(n)” illustrated in FIG. 9 indicates output speech upon which a characteristic sound has been mixed by the mixing unit 280E. In addition, “artSig(n)” illustrated in FIG. 9 indicates a characteristic sound generated by the generation unit 280D, and “receiver_flag” illustrated in FIG. 9 indicates a flag input from the above-described detection unit 280A. In addition, “SW” illustrated in FIG. 9 indicates a switch that can be turned on and off in accordance with the flag input from the above-described detection unit 280A.

For example, the mixing unit 280E obtains the value of a flag set by the detection unit 280A and judges whether or not the obtained value of a flag is a value (receiver_flag=1) indicating that the user is in a telephone call state in which he/she is using either of his/her ears. If it has been judged that the user is in a telephone call state in which he/she is using either of his/her ears (if receiver_flag=1), the mixing unit 280E turns on the switch SW. The mixing unit 280E then mixes the characteristic sound “artSig(n)” generated by the generation unit 280D with the speech “SpOut(n)” input from the processing unit 290 in order to generate “SigOut(n)”. The mixing unit 280E then plays back “SigOut(n)” and outputs “SigOut(n)” from the speaker 202 in monaural output, where a single output system is used.

In addition, if a certain value indicating that the user is in a telephone call state in which he/she is using headphones, earphones, or the like is set for a flag input from the above-described detection unit 280A (if receiver_flag=2), the mixing unit 280E turns off the switch SW. In this case, the mixing unit 280E plays back the speech “SpOut(n)” input from the processing unit 290 and outputs the speech “SpOut(n)” from the speaker 202 in stereo output, where two output system different between the left and right are used. It is to be noted that the generation unit 280D and the mixing unit 280E are examples of a determination unit.

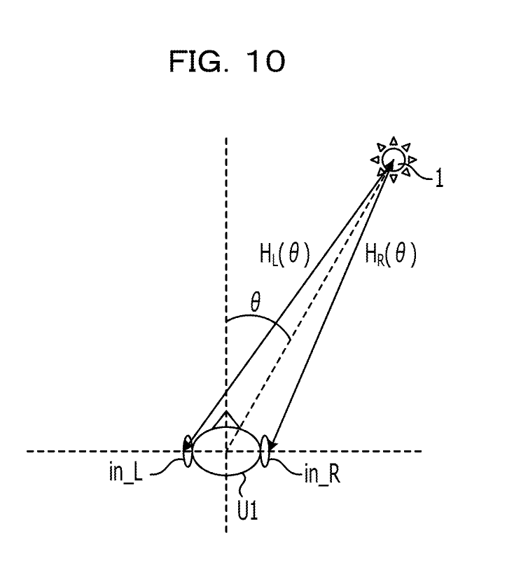

The processing unit 290 processes, in accordance with the content of a flag set by the detection unit 280A with respect to the telephone call state of the user, speech decoded by the decoder 270. The processing unit 290 will be described with reference to FIG. 10. FIG. 10 is used to describe a generation unit according to the first embodiment. “U1” illustrated in FIG. 10 indicates a user who is using the terminal apparatus 200. In addition, “H_{R}(θ)” illustrated in FIG. 10 indicates a head-related transfer function (impulse response) at a time when speech is input to the right ear of the user U1 from a speech source 1. In addition, “H_{L}(θ)” illustrated in FIG. 10 indicates a head-related transfer function (impulse response) at a time when speech is input to the left ear of the user U1 from the speech source 1. In addition, “in_R” illustrated in FIG. 10 indicates speech input to the user's right ear from the speech source 1. In addition, “in_L” illustrated in FIG. 10 indicates speech input to the user's left ear from the speech source 1.

For example, if a certain value indicating that the user is in a telephone call state in which he/she is using either of his/her ears is set for a flag input from the above-described detection unit 280A (if receiver_flag=1), the processing unit 290 performs processing in the following manner. That is, the processing unit 290 transmits speech decoded by the decoder 270 to the mixing unit 280E as it is.

On the other hand, if a certain value indicating that the user is in a telephone call state in which he/she is using headphones, earphones, or the like is set for a flag input from the above-described detection unit 280A (if receiver_flag=2), the processing unit 290 performs processing in the following manner. That is, the processing unit 290 substitutes the relative angle calculated by the calculation unit 260 for “θ” and uses the following expressions (4-1) and (4-2) to generate speech for the left ear and the right ear, respectively. It is to be noted that the expressions (4-1) and (4-2) are convolution calculation between a head-related transfer function (impulse response) and a speech signal S from the speech source 1, and, for example, a finite impulse response (FIR) filter is used therefor.

$$\begin{matrix}in\_L ( θ , n ) = {\sum }_{m = 0}^{M - 1} hrtfL ( θ , m ) \cdot sig ( n - m ) & ( 4 \text{-} 1 ) \\ in\_R ( θ , n ) = {\sum }_{m = 0}^{M - 1} hrtfR ( θ , m ) \cdot sig ( n - m ) & ( 4 \text{-} 2 )\end{matrix}$$

sig(n): Speech signal S

hrtfL(θ,m)(m=0, . . . , M−1): Impulse response of H_{L}(θ)

hrtfR(θ,m)(m=0, . . . , M−1): Impulse response of H_{R}(θ)

M: Length of impulse response

The processing unit 290 then transmits the speech for the right ear and the left ear generated by using the above expressions (4-1) and (4-2) to the mixing unit 280E. It is to be noted that, as described above, if the user is in a telephone call state in which he/she is using headphones, earphones, or the like, the mixing unit 280E does not mix a characteristic sound with the speech for the right ear and the left ear, and the speech for the right ear and the left ear are output from the mixing unit 280E as they are.

The above-described terminal apparatus 100 and terminal apparatus 200 have, for example, a semiconductor memory devices such as random-access memories (RAMs) or flash memories, which are used for various processes. In addition, the above-described terminal apparatus 100 and terminal apparatus 200 have electronic circuits such as central processing units (CPUs) or micro processing units (MPUs) and use the RAMs or the flash memories to execute various processes. It is to be noted that the above-described terminal apparatus 100 and terminal apparatus 200 may have integrated circuits such as application-specific integrated circuits (ASICs) or field-programmable gate arrays (FPGAs) instead of the CPUs or the MPUs.

Processing Performed by Terminal Apparatus (First Embodiment)

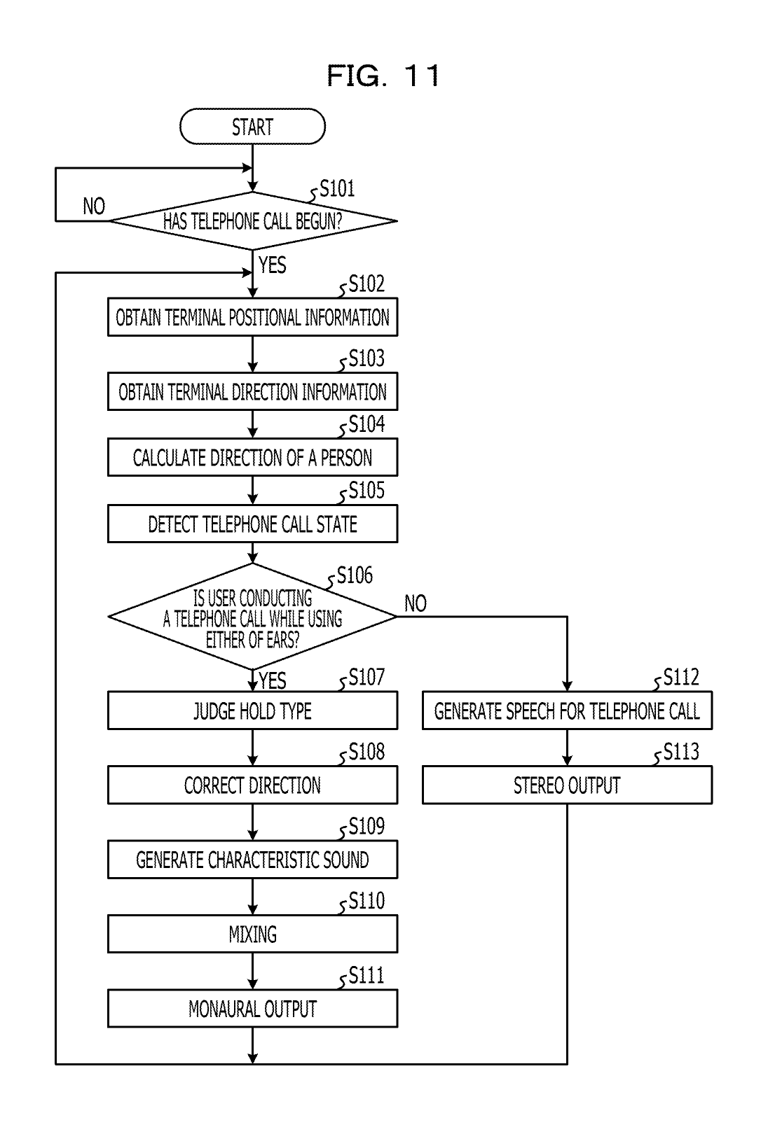

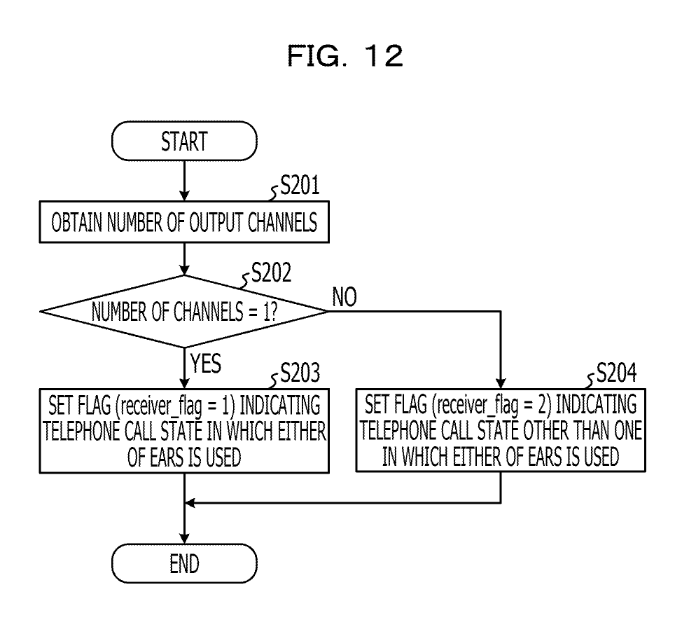

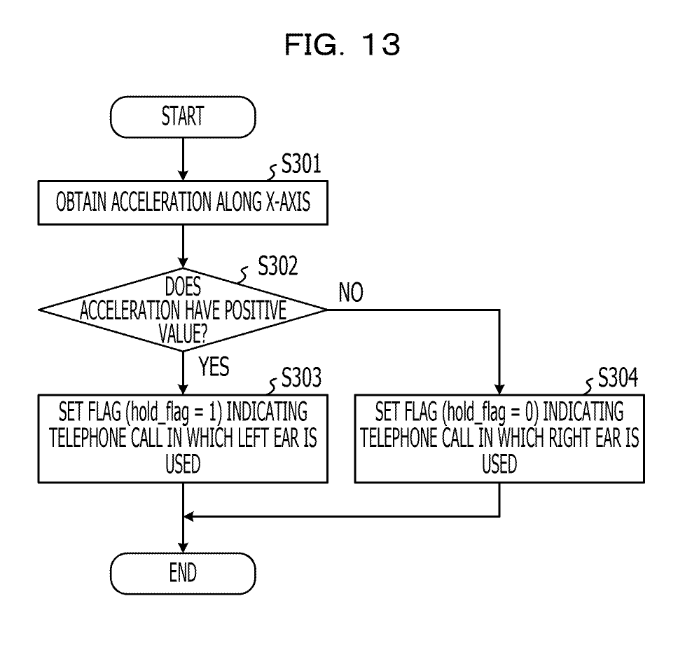

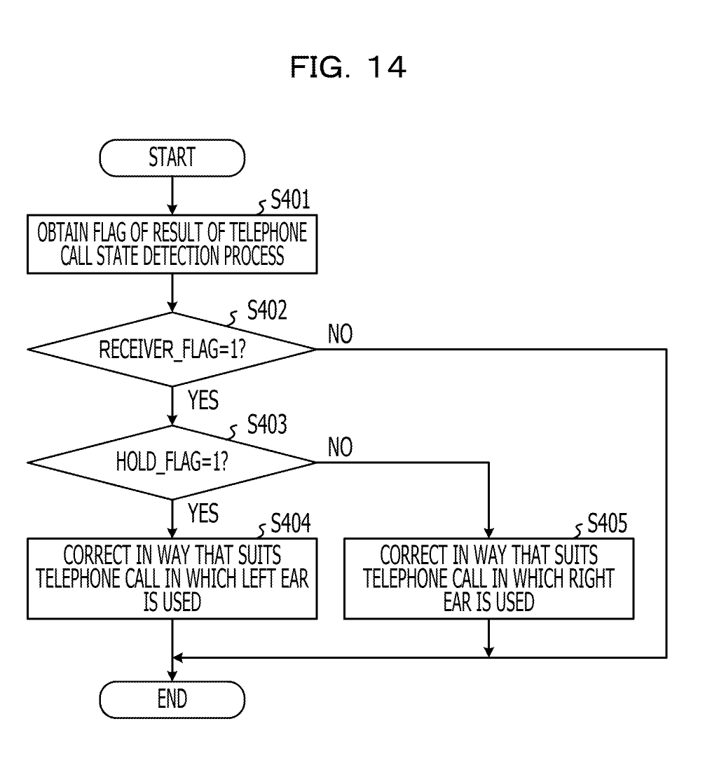

The flow of processing performed by the above-described terminal apparatus 200 will be described with reference to FIGS. 11 to 14. FIG. 11 illustrates the general processing flow of a terminal apparatus according to the first embodiment. FIG. 12 illustrates the flow of a telephone call state detection process according to the first embodiment. FIG. 13 illustrates the flow of a hold type judgment process according to the first embodiment. FIG. 14 illustrates the flow of a direction correction process according to the first embodiment.

First, the general processing flow of the terminal apparatus 200 will be described with reference to FIG. 11. As illustrated in FIG. 11, the terminal apparatus 200, for example, monitors presence/absence of operation of a telephone call button to detect the beginning of a telephone call. If the beginning of a telephone call has been detected (YES in step S101), the position obtaining unit 220 obtains the positional information of the terminal apparatus 200 (step S102). If the beginning of a telephone call has not been detected (NO in step S101), the terminal apparatus 200 continues to monitor presence/absence of operation of the telephone call button until the beginning of a telephone call is detected.

Next, the direction obtaining unit 250 obtains information regarding the terminal direction of the terminal apparatus 200 (step S103). Next, the calculation unit 260 calculates the relative angle of the direction of the person, that is, a direction from the position of the terminal apparatus 200 to the position of the terminal apparatus 100, in relation to the terminal direction of the terminal apparatus 200 (step S104).

Next, the detection unit 280A executes the telephone call state detection process (step S105). Next, the detection unit 280A judges, as a result of the telephone call state detection process in step S105, whether or not the user is in a telephone call state in which he/she is using either of his/her ears (step S106). If it has been judged by the detection unit 280A, for example, that the user is in a telephone call state in which he/she is using either of his/her ears (YES in step S106), the judgment unit 280B executes the hold type judgment process, where whether the user is conducting the telephone call while using his/her right ear or left ear is judged (step S107).

Next, the correction unit 280C uses the correction values predetermined for a telephone call in which the right ear is used and a telephone call in which the left ear is used in order to execute the direction correction process, where the direction of the person calculated in step S104, that is, the relative angle, is corrected (step S108). Next, the generation unit 280D generates, in accordance with the direction of the person corrected in step S108, a characteristic sound to be mixed to the speech received from the terminal apparatus 100 (step S109).

Next, if the user is in a telephone call state in which he/she is using either of his/her ears, the mixing unit 280E mixes the characteristic sound generated in step S109 to the speech received from the terminal apparatus 100 (step S110). The mixing unit 280E then outputs the speech and the characteristic sound mixed in step S110 in monaural (step S111), where a single system is used, and the processing returns to the above-described process in step S102.

Now, description returns to step S106. If it has been judged by the detection unit 280A that the user is in a telephone call state other than the telephone call state in which he/she is using either of his/her ears, that is, a telephone call state in which, for example, he/she is using headphones, earphones, or the like (NO in step S106), the processing unit 290 executes the following process. That is, the processing unit 290 generates speech for the right ear and the left ear from the speech received from the terminal apparatus 100 on the basis of the relative angle calculated in step S104 (step S112). Next, the mixing unit 280E outputs the speech for the right ear and the left ear generated in step S112 as they are in stereo (step S113), where output systems different between the left and right are used. The processing returns to the above-described process in step S102.

It is to be noted that if a telephone call in which the terminal apparatus 200 is used can be assumed to be invariably performed in a situation in which either of the user's ears is used, the processing need not be necessarily executed in accordance with the above-described flow illustrated in FIG. 11. For example, the processing may be executed in order from the above-described step S101 to step S104 and then from step S107 to step S111.

Next, the flow of the telephone call state detection process will be described with reference to FIG. 12. As illustrated in FIG. 12, the detection unit 280A obtains the number of channels of a speech output path (step S201) and judges whether or not the number of channels is one (step S202). If it has been judged that the number of channels is one (YES in step S202), the detection unit 280A judges that the user is in a telephone call state in which he/she is using either of his/her ears. The detection unit 280A then sets, for a certain flag, a certain value indicating that the user is in a telephone call state in which he/she is using either of his/her ears (receiver_flag=1, step S203).

Description returns to step S202. If it has been judged that the number of channels is not one (NO in step S202), the detection unit 280A judges that the user is in a telephone call state other than a telephone call state in which he/she is using either of his/her ears, that is, a telephone call state in which, for example, he/she is using headphones, earphones, or the like. The detection unit 280A then sets, for a certain flag, a certain value indicating that the user is in a telephone call state in which, for example, he/she is using headphones, earphones, or the like (receiver_flag=2, step S204).

Next, the flow of the hold type judgment process will be described with reference to FIG. 13. It is to be noted that the hold type judgment process corresponds to a process in which whether the user is conducting a telephone call while using his/her right ear or left ear is judged.

As illustrated in FIG. 13, the judgment unit 280B obtains the acceleration along the x-axis from the acceleration sensor (step S301). The judgment unit 280B then judges whether or not the obtained acceleration along the x-axis has a positive value (step S302).

If it has been judged that the acceleration along the x-axis has a positive value (YES in step S302), the judgment unit 280B judges that the user is conducting the telephone call while using his/her left ear. The judgment unit 280B then sets, for a certain flag, a certain value indicating a telephone call in which the left ear is used (hold_flag=1, step S303).

Description returns to step S302. If it has been judged that the acceleration along the x-axis does not have a positive value, that is, the acceleration along the x-axis has a negative value (NO in step S302), the judgment unit 280B judges that the user is conducting the telephone call while using his/her right ear. The judgment unit 280B then sets, for a certain flag, a certain value indicating a telephone call in which the right ear is used (hold_flag=0, step S304).

Next, the flow of the direction correction process will be described with reference to FIG. 14. It is to be noted that the direction correction process corresponds to a process in which the corrected relative angle “ang6 (relative_angle2)”, which is an angle obtained by correcting the relative angle calculated by the calculation unit 260, is obtained by using correction values predetermined for a telephone call in which the right ear is used and a telephone call in which the left ear is used.

As illustrated in FIG. 14, the correction unit 280C obtains the value of a flag set by the detection unit 280A (step S401) as a result of the telephone call state detection process, which has been described with reference to FIG. 12. Next, the correction unit 280C judges whether or not the obtained value of a flag is a value (receiver_flag=1) indicating that the user is in a telephone call state in which he/she is using either of his/her ears (step S402).

If it has been judged that the obtained value of a flag is a value indicating that the user is in a telephone call state in which he/she is using either of his/her ears (YES in step S402), the correction unit 280C obtains the value of a flag set by the judgment unit 280B. The correction unit 280C then judges whether or not the obtained value of a flag is a value (hold_flag=1) indicating a telephone call in which the left ear is used (step S403). If it has been judged that the obtained value of a flag is a value indicating a telephone call in which the left ear is used (YES in step S403), the correction unit 280C obtains the correction value “ang4 (delta_angle_L)” for a telephone call in which the left ear is used. The correction unit 280C then uses the correction value for a telephone call in which the left ear is used in order to correct the relative angle “ang3 (relative_angle1)” calculated by the calculation unit 260 in a way that suits a telephone call in which the left ear is used (step S404). By this correction, for example, the corrected relative angle “ang6 (relative_angle2)” illustrated in FIG. 6 is calculated.

Description returns to step S403. If it has been judged that the obtained value of a flag is not a value indicating a telephone call in which the left ear is used, that is, the obtained value of a flag is a value (hold_flag=0) indicating a telephone call in which the right ear is used (NO in step S403), the correction unit 280C performs the following process. That is, the correction unit 280C obtains the correction value “ang5 (delta_angle_R)” for a telephone call in which the right ear is used. The correction unit 280C then uses the correction value for a telephone call in which the right ear is used in order to correct the relative angle “ang3 (relative_angle1)” calculated by the calculation unit 260 in a way that suits a telephone call in which the right ear is used (step S405). By this correction, for example, the corrected relative angle “ang6 (relative_angle2)” illustrated in FIG. 6 is calculated.

Description returns to step S402. If it has been judged that the value of a flag set by the detection unit 280A is not a value indicating that the user is in a telephone call state in which he/she is using either of his/her ears (NO in step S402), the correction unit 280C immediately ends the direction correction process.

### Advantageous Effects Produced by First Embodiment

As described above, when a telephone call state in which the user is using either of his/her ears has been detected, the terminal apparatus 200 according to the first embodiment corrects, by a certain angle, the relative angle between the direction from the terminal apparatus 200 to the terminal apparatus 100, which is used by a person with whom the user is conducting a telephone call, and the terminal direction of the terminal apparatus 200. The terminal apparatus 200 then determines the attribute of output speech in accordance with the corrected relative angle. Therefore, according to the first embodiment, it is possible to allow a user who is conducting a telephone call while using either of his/her ears to exactly perceive the direction of a person with whom he/she is conducting the telephone call.

In addition, according to the first embodiment, the relative angle between the direction from the terminal apparatus 200 to the terminal apparatus 100, which is used by a person with whom the user is conducting a telephone call, and the terminal direction of the terminal apparatus 200 is corrected by using correction values predetermined for a telephone call in which the right ear is used and a telephone call in which the left ear is used. Therefore, even when the user is conducting a telephone call while using either of his/her ears, it is possible to accurately calculate the relative angle for a telephone call in which the right ear is used and a telephone call in which the left ear is used at a time when the terminal direction of the terminal apparatus 200 and the front direction of the user are matched. As a result, it is possible to improve the accuracy of the direction of a person with whom the user is conducting a telephone call, which is perceived by the user. It is to be noted that the correction of the relative angle between the direction from the terminal apparatus 200 to the terminal apparatus 100, which is used by a person with whom the user is conducting a telephone call, and the terminal direction of the terminal apparatus 200 is not limited to a case in which the correction values predetermined for a telephone call in which the right ear is used and a telephone call in which the left ear is used are used. For example, in view of the fact that the angle between the terminal direction and the front direction of the user is frequently about 180°, the relative angle between the direction from the terminal apparatus 200 to the terminal apparatus 100, which is used by a person with whom the user is conducting a telephone call, and the terminal direction of the terminal apparatus 200 may be, for example, corrected by 180°.

In addition, according to the first embodiment, a characteristic sound is generated whose volume becomes larger as the corrected relative angle becomes smaller, and the generated characteristic sound is mixed to speech during a telephone call. Therefore, since the direction of a person with whom a user is conducting a telephone call is not expressed by the difference between speech for the left ear and speech for the right ear, it is possible to allow a user who is conducting a telephone call while using either of his/her ears to exactly perceive the direction of the person with whom he/she is conducting the telephone call. It is to be noted that even if the person with whom the user is conducting a telephone call remains silent, it is possible to allow the user to perceive the direction of the person with whom he/she is conducting the telephone call by mixing a characteristic sound to the silence during the telephone call received from the terminal apparatus 100.

In addition, in the above-described first embodiment, for example, when mixing a characteristic sound generated by the generation unit 280D to speech input from the processing unit 290, the mixing unit 280E may perform acoustic processing using a head-related transfer function. For example, the mixing unit 280E performs acoustic processing in such a way that speech input from the processing unit 290 and a characteristic sound generated by the generation unit 280D are transmitted from virtual speech sources whose positions are different from each other. The mixing unit 280E then mixes the characteristic sound with the speech and outputs the resulting sound. For example, the mixing unit 280E superimposes the characteristic sound upon the speech and outputs the resulting sound. In doing so, the speech of the person (output speech) and the characteristic sound can be played back from different directions (for example, from upper and lower directions), thereby making it possible for the user to easily distinguish between the speech and the characteristic sound. That is, even when a characteristic sound has been mixed with speech of the person in a telephone call state in which the user is using either of his/her ears, the speech and the characteristic sound can be prevented from being difficult to distinguish.

### Second Embodiment

A terminal apparatus and a speech processing program according to a second embodiment disclosed herein will be described hereinafter.

(1) Configuration of Apparatus etc.

For example, the above-described configuration of the terminal apparatus 200 illustrated in FIG. 1 is conceptualized in terms of the functions, and therefore the terminal apparatus 200 need not be necessarily configured physically as illustrated in FIG. 1. For example, the detection unit 280A, the judgment unit 280B, the correction unit 280C, the generation unit 280D, and the mixing unit 280E illustrated in FIG. 1 may be functionally or physically integrated as a single unit. Thus, the terminal apparatus 200 may be configured in such a way that all or some of the processing function units included therein are functionally or physically divided or integrated in an arbitrary unit in accordance with various loads and a use condition.

(2) Hardware Configuration of Terminal Apparatus

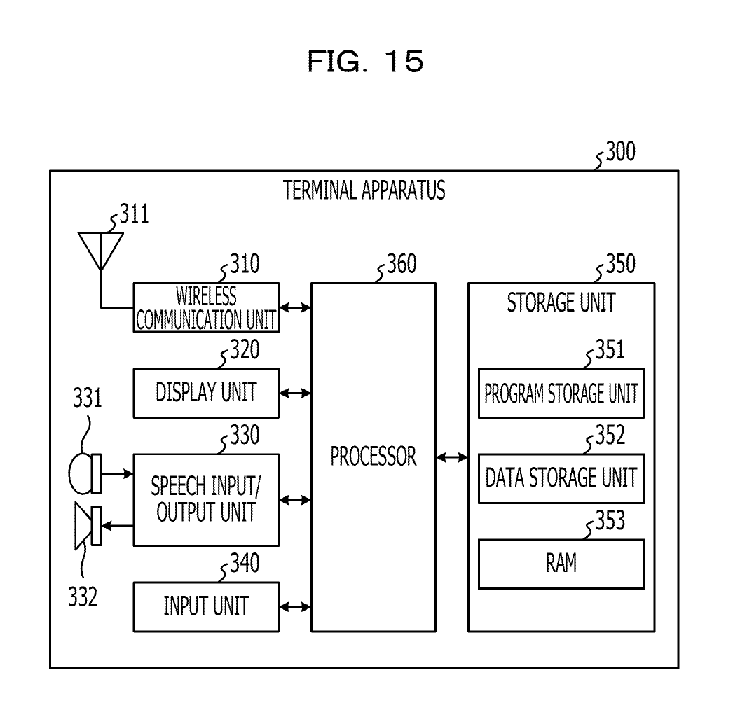

Next, an example of the hardware configuration of a terminal apparatus according to the second embodiment will be described with reference to FIG. 15. FIG. 15 illustrates an example of the hardware configuration of the terminal apparatus. As illustrated in FIG. 15, a terminal apparatus 300 has a wireless communication unit 310, an antenna 311, a display unit 320, a speech input/output unit 330, a microphone 331, a speaker 332, an input unit 340, a storage unit 350, and a processor 360.

The wireless communication unit 310, the display unit 320, the speech input/output unit 330, the input unit 340, and the storage unit 350 are connected to the processor 360. In addition, the antenna 311 is connected to the wireless communication unit 310. In addition, the microphone 331 and the speaker 332 are connected to the speech input/output unit 330.

The wireless communication unit 310 corresponds to, for example, a communication control unit, which is not illustrated in FIG. 1, included in the terminal apparatus 200. In addition, the display unit 320 corresponds to, for example, a display, which is not illustrated in FIG. 1, included in the terminal apparatus 200. The speech input/output unit 330, the microphone 331, and the speaker 332 correspond to, for example, the microphone 201 and the speaker 202 illustrated in FIG. 1 and an input/output control unit, which is not illustrated in FIG. 1, included in the terminal apparatus 200. In addition, the input unit 340 corresponds to, for example, a key control unit, which is not illustrated in FIG. 1, included in the terminal apparatus 200.

The storage unit 350 and the processor 360 realize, for example, the functions of the detection unit 280A, the judgment unit 280B, the correction unit 280C, the generation unit 280D, the mixing unit 280E, and the like illustrated in FIG. 1. More specifically, a non-transitory program storage unit 351 in the storage unit 350 stores, for example, various computer programs for realizing the processes illustrated in FIGS. 11 to 14 and the like, such as the speech processing program. The processor 360 reads and executes the computer programs stored in the program storage unit 351 in order to generate the processes for realizing the above-described functions. In addition, a data storage unit 352 holds, for example, various pieces of data to be used for the processes illustrated in FIGS. 11 to 14 and the like. In addition, a RAM 353 has, for example, a storage region to be used for the processes generated by the processor 360 when the processes illustrated in FIGS. 11 to 14 and the like are executed.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

What is claimed is:

1. A terminal apparatus comprising:
an own-terminal position obtaining unit that obtains positional information indicating a position of the terminal apparatus;
an another-terminal position obtaining unit that obtains positional information indicating a position of another apparatus;
a first direction obtaining unit that obtains a first direction, which is a direction to the obtained position of the another apparatus and calculated using the obtained position of the terminal apparatus as a reference point;
a second direction obtaining unit that obtains a second direction, which is a direction in which the terminal apparatus is oriented;
an inclination direction obtaining unit that obtains, using a sensor that detects a direction in which the terminal apparatus is inclined, inclination information indicating whether the terminal apparatus is inclined to the right or to the left;
a correction unit that switches an amount of correction for a relative angle between the first direction and the second direction in accordance with whether the obtained inclination information indicates an inclination to the right or an inclination to the left; and
a determination unit that determines an attribute of speech output from a speech output unit in accordance with the relative angle corrected by the amount of correction.

2. The terminal apparatus according to claim 1, further comprising:
a number-of-signals judgment unit that judges whether or not the number of channels of a speech output path is one when the speech is output during a telephone call,
wherein, if it has been judged by the number-of-signals judgment unit that the number of signals is more than one, the correction unit does not execute a process for correcting the relative angle by the amount of correction.

3. The terminal apparatus according to claim 2, further comprising:
a generation unit that generates a characteristic sound according to the relative angle corrected by the correction unit,
wherein the determination unit determines a sound obtained by the characteristic sound being mixed with the speech output during a telephone call as the attribute of the speech output from the speech output unit.

4. The terminal apparatus according to claim 3,
wherein the determination unit uses a head-related transfer function to process the speech output during a telephone call and the characteristic sound in such a way that the speech output and the characteristic sound are transmitted from virtual speech sources whose positions are different from each other, and determines a sound obtained by the processed characteristic sound being mixed with the processed speech as the attribute of the speech output from the speech output unit.

5. A program stored in a non-transitory computer readable medium for causing a computer to execute processing of a terminal apparatus including:
an own-terminal position obtaining unit that obtains positional information indicating a position of the terminal apparatus;
an another-terminal position obtaining unit that obtains positional information indicating a position of another apparatus;
a first direction obtaining unit that obtains a first direction, which is a direction to the obtained position of the another apparatus and calculated using the obtained position of the terminal apparatus as a reference point;
a second direction obtaining unit that obtains a second direction, which is a direction in which the terminal apparatus is oriented;
an inclination direction obtaining unit that obtains, using a sensor that detects a direction in which the terminal apparatus is inclined, inclination information indicating whether the terminal apparatus is inclined to the right or to the left;
a correction unit that switches an amount of correction for a relative angle between the first direction and the second direction in accordance with whether the obtained inclination information indicates an inclination to the right or an inclination to the left; and
a determination unit that determines an attribute of speech output from a speech output unit in accordance with the relative angle corrected by the amount of correction.
